(19) United States
(12) Patent Application Publication
(10) Pub. No.: US 2002/0107829 A1
(43) Pub. Date: Aug. 8, 2002

(54) System, method and computer program product for catching, marking, managing and searching content

(76) Inventors: Kolbeinn Sigurjonsson, Mosfellsbai (IS); Tryggvi Sch. Thorsteinsson, Reykjavik (IS); Thorvaldur Ingi Jonsson, Kopavogi (IS)

Correspondence Address: VENABLE, Post Office Box 34385, Washington, DC, 20043-9998, US

(21) Appl. No.: 09/773,489

(22) Filed: Feb. 2, 2001

(51) Int. Cl. G06F 7/00

(52) U.S. Cl. 707/1

(57) ABSTRACT

A system, method and computer program product for organizing can include catching, marking, managing, searching, fixing and playing content. The catcher can include registering the content in a database. The catcher can assign the content to an album. The marking method can include marking content including managing a hierarchy of tag and subtag attributes, creating a new tag attribute; changing a hierarchical relationship of one tag attribute and subtag attributes of the one tag attribute; deleting an undesired tag attribute; renaming a misnamed tag attribute, or displaying the hierarchy of tag and sub-tag attributes as a tag tree list. The method can further include associating any of the tag attributes with any of the content. Associating can be done by dragging and dropping tags from the tag tree list to content records or the catcher. The method can further include searching the content by one or more search tag attributes. The manager can also be used to mark and organize the content in albums.

### BACKGROUND OF THE INVENTION

1. Field of the Invention

The present invention relates generally to file management systems, and more particularly to content file management systems.

2. Related Art

Over the past few years, the number and types of files that computer users store and use on their computers have increased enormously. In addition to traditional text files, people now store all types of content information, e.g., digital images captured from cameras (still and video) and scanners. Music and sounds can also be digitized and stored on computers. The growth in the number and types of content, combined with the ever-increasing capacity of storage media, creates a file management and retrieval problem. The less a user remembers about the details of the file, such as, e.g., the file's name, location, format or creation date, the longer it takes to retrieve the file from storage media, if the file can be located at all.

Conventionally files have been organized using an operating system's file directory and subdirectory structure. Even with a well-organized file storage structure, however, the user is typically limited to grouping related files in directories or sub-directories. Files that fall into more than one filing category for the user might be duplicated in the directory structure, e.g. found in both the “family” and “Vacation pictures” directories. Alternatively, the directory structure itself might be duplicated, e.g. “. . . /Family/Vacation Pictures” and “. . . /Pictures/Vacation/Family”, and so on. Unfortunately, duplication of files and directories uses additional media storage space and compounds the problem of fast file location and retrieval. Additional storage space can translate directly to additional costs. Time spent retrieving files translates to lost productivity.

Conventional software applications that attempt to solve these problems, such as, e.g., FlipAlbum™ available from e-Book Systems™ Inc. of Santa Clara, Calif., U.S.A., and ACDSee™ available from ACD Systems International Inc. of Saanichton, British Columbia, Canada, provide the ability to organize image files into albums. Users can also edit images, produce slide-shows, and browse their images as thumbnails. Unfortunately, none of these conventional applications provides ways of managing multiple types of content files beyond images, such as video or sound files. Nor do the conventional software applications provide any enhanced ability to locate files on the user's hard drive or other storage media.

What is needed, is a method of capturing content from many sources and organizing the content for quick and easy retrieval.

### SUMMARY OF THE INVENTION

In an exemplary embodiment of the present invention a system, method and computer program product for organizing content is disclosed.

An exemplary embodiment of the present invention can include a method including (a) catching content which can include (1) registering the content in a database.

In an exemplary embodiment the step (a)(1) can include (A) generating a copy of the content, where the copy is stored in a common directory or a selected directory. In an exemplary embodiment the step (a)(1)(A) can include (i) compressing the content.

In an exemplary embodiment the step (a)(1) can include (A) assigning the content to an album. In an exemplary embodiment the step (a)(1)(A) can include (i) selecting an album from a group of albums where the album or the group of albums do not correspond directly to a file directory structure of an operating system; the group of albums can include art and entertainment, cartoons, home and family, internet, music, news, sports, traveling, or videos; the albums and the group of albums are user customizable; or the albums and the group of albums are user selectable at installation.

In an exemplary embodiment the step (a) can be performed by a catcher and where the catcher performs displaying a catcher window, communicating wirelessly, standing alone as an independent software application, and displaying a task bar version of the catcher.

In an exemplary embodiment the database can be a manager or an album database of user-definable albums.

In an exemplary embodiment the step (a) can further include (2) previewing the content.

In an exemplary embodiment the step (a) further can include (2) capturing the content. In an exemplary embodiment the step (a)(2) can include (A) receiving the content from a main memory; a secondary memory; storage media; a browser; a scanner; a microphone; a line in; a digital camera; a source of content; and a video camera. In an exemplary embodiment the step (a)(2)(A) can include the storage media, where the storage media can be a hard disk, removable media, CD-ROM, DVD, Flash memory, a floppy disk, a ZIP drive, an optical storage device, a magneto-optical storage device, or a magnetic storage device.

In an exemplary embodiment the step (a) further can include (2) storing the content to a storage media. In an exemplary embodiment the step (a)(2) can include (A) storing content where the content can include at least one of data, digital images, text, audio, music, video, and movies.

In an exemplary embodiment the step (a) further can include (2) setting attributes of the content within the database. In an exemplary embodiment the step (a)(2) can include (A) setting attributes where the attributes can include at least one of a tag attribute, a user definable attribute, an album attribute, a name attribute, a name of a copy of a file, an owner attribute, an artist attribute, a location attribute, a content attribute, an audio attribute, a video attribute, a universal resource locator attribute, a memo attribute, a filename and path attribute, a label attribute, an identifier of storage media, other fixed attributes, and other user definable attributes.

In an exemplary embodiment the step (a)(1) can include (A) dragging the content to a capture window; and (B) dropping the content into the capture window.

In an exemplary embodiment the step (a)(1) can include (A) selecting a menu choice; (B) selecting a button; (C) selecting a menu choice from a popup menu associated with content; or (D) browsing user's files to select content to register.

In an exemplary embodiment the step (a)(1) can include (A) generating a copy of the content. In an exemplary embodiment the step (a)(1)(A) can include (i) assigning a user-specified location on storage media.

In an exemplary embodiment the step (a) further can include (2) assigning content to existing content as a memo attribute.

In an exemplary embodiment the method can further include (b) managing the content can include (1) organizing the content in an album of a group of albums in a hierarchical album structure where the hierarchical album structure need not mirror an operating system file directory structure; (2) displaying the hierarchical album structure as a collapsible and expandable album tree; (3) displaying attributes of the content where the attributes can include a tag attribute, a user definable attribute, an album attribute, a name attribute, a name of a copy of a file, an owner attribute, an artist attribute, a location attribute, a content attribute, an audio attribute, a video attribute, a universal resource locator attribute, a memo attribute, a filename and path attribute, a label attribute, an identifier of storage media, other fixed attributes, or other user definable attributes; (4) modifying attributes where the attributes can include a tag attribute, a user definable attribute, an album attribute, a name attribute, a name of a copy of a file, an owner attribute, an artist attribute, a location attribute, a content attribute, an audio attribute, a video attribute, a universal resource locator attribute, a memo attribute, a filename and path attribute, a label attribute, an identifier of storage media, other fixed attributes, or other user definable attributes; or (5) previewing the content; (6) outputting the content to at least one of a display and a printer; (7) generating one or more thumbnail views of the content and displaying, storing, or outputting the one or more thumbnail views or details associated with the one or more thumbnail views. In an exemplary embodiment each of the step (a) and the step (b) can be a separate software application program.

In an exemplary embodiment the method further can include (c) marking the content can include (1) managing a hierarchy of tag and subtag attributes, can include (A) creating a new tag attribute can include (i) selecting a parent tag attribute, and (ii) assigning a new child tag attribute to the parent tag attribute, (B) changing a hierarchical relationship of one tag attribute and subtag attributes of the one tag attribute can include (i) reassigning the one tag attribute and the subtag attributes of the one tag attribute to a different parent tag attribute, (C) deleting an undesired tag attribute can include (i) selecting the undesired tag attribute, and (ii) deleting the undesired tag attribute and any subtag attributes of the undesired tag attribute, (D) renaming a misnamed tag attribute, or (E) displaying the hierarchy of tag and sub-tag attributes as a tag tree list. In an exemplary embodiment the step (c) further can include (2) associating any of the tag attributes with any of the content can include (A) selecting the any of the tag attributes, and (B) associating the any of the tag attributes with one or more content records of the content. In an exemplary embodiment the step (c)(2)(B) can include (i) dragging and dropping the one or more tags from the tag tree list to the content records or the capture window. In an exemplary embodiment the hierarchy of tag and subtag attributes can include at least one root tag, and where each tag beginning from the root tag can have one or more subtags assigned to the each tag, and each subtag is a tag, and the each subtag is assigned as a child tag of one parent tag.

In an exemplary embodiment the method can further include (d) searching the content can include (1) selecting one or more search tag attributes, (2) querying the database for matching content having the search tag attributes and subtags of the search tag attributes associated with the matching content.

In an exemplary embodiment the method can further include (d) searching the content can include (1) selecting at least one of a user-defined attributes, (2) querying the database for matching content having the user-defined attributes associated with the matching content.

In an exemplary embodiment the method can further include (c) fixing the content can include importing, can include selecting the content, opening the content, or converting the content from a first format to a second format; editing the content, can include rotating, sizing, zooming, applying filters, or adjusting colors; storing the content; viewing the content can include fitting content to window size, or fitting window to content size; cropping the content; emailing the content; or modifying the content according to criteria can include file size, zooming, portion of image, user selection, automatically according to default criteria, or selectively according to selected criteria.

In an exemplary embodiment the method can further include (c) playing the content can include selecting the content; organizing the content; reordering the content; appending the content; displaying one or more content records of the content in a slideshow format, or the thumbnail views; or exporting the slideshows as stand-alone viewable applications.

In an exemplary embodiment the method can further include supporting multiple languages.

In another exemplary embodiment of the invention, a method of marking content can include (a) marking content can include (1) managing a hierarchy of tag and subtag attributes, can include (A) creating a new tag attribute can include (i) selecting a parent tag attribute, and (ii) assigning a new child tag attribute to the parent tag attribute, (B) changing a hierarchical relationship of one tag attribute and subtag attributes of the one tag attribute can include (i) reassigning the one tag attribute and the subtag attributes of the one tag attribute to a different parent tag attribute, (C) deleting an undesired tag attribute can include (i) selecting the undesired tag attribute, and (ii) deleting the undesired tag attribute and any subtag attributes of the undesired tag attribute, (D) renaming a misnamed tag attribute, or (E) displaying the hierarchy of tag and sub-tag attributes as a tag tree list. In an exemplary embodiment the step (a) further can include (2) associating any of the tag attributes with any of the content can include (A) selecting the any of the tag attributes, and (B) associating the any of the tag attributes with one or more content records of the content. In an exemplary embodiment the step (a)(2)(B) can include (i) dragging and dropping the one or more tags from the tag tree list to at least one of the content records and the capture window. In an exemplary embodiment the hierarchy of tag and subtag attributes can include at least one root tag, and where each tag beginning from the root tag can have one or more subtags assigned to the each tag, and each subtag is a tag, and the each subtag is assigned as a child tag of one parent tag.

In an exemplary embodiment the method can further include (b) searching the content can include (1) selecting one or more search tag attributes, (2) querying the database for matching content having the search tag attributes and subtags of the search tag attributes associated with the matching content.

In an exemplary embodiment the method can further include (b) searching the content can include (1) selecting at least one of a user-defined attributes, (2) querying the database for matching content having the user-defined attributes associated with the matching content.

In yet another exemplary embodiment of the invention, a method of organizing content can include (a) managing content. The step (a) can include (1) organizing the content in an album of a group of albums in a hierarchical album structure where the hierarchical album structure need not mirror an operating system file directory structure; (2) displaying the hierarchical album structure as a collapsible and expandable album tree; (3) displaying attributes of the content where the attributes can include a tag attribute, a user definable attribute, an album attribute, a name attribute, a name of a copy of a file, an owner attribute, an artist attribute, a location attribute, a content attribute, an audio attribute, a video attribute, a universal resource locator attribute, a memo attribute, a filename and path attribute, a label attribute, an identifier of storage media, other fixed attributes, or other user definable attributes; (4) modifying attributes where the attributes can include a tag attribute, a user definable attribute, an album attribute, a name attribute, a name of a copy of a file, an owner attribute, an artist attribute, a location attribute, a content attribute, an audio attribute, a video attribute, a universal resource locator attribute, a memo attribute, a filename and path attribute, a label attribute, an identifier of storage media, other fixed attributes, or other user definable attributes; (5) previewing the content; (6) outputting the content to a display or a printer; (7) generating one or more thumbnail views of the content and displaying, storing, or outputting the one or more thumbnail views or details associated with the one or more thumbnail views.

In another exemplary embodiment of the invention, a system that catches content can include a processor; a memory coupled to the processor; and a catcher module executable on the processor operative to catch content. In another exemplary embodiment, the system can further include a network that can be wireless or wired. In another exemplary embodiment, the system can further include a server including a second processor, a second memory and storage media.

In an exemplary embodiment, the catcher module can be displayed, a wireless communication enabled software application, a standalone software application, or a task bar software application.

In another exemplary embodiment of the invention, a system that marks content can include a processor; a memory coupled to the processor; a marker module executable on the processor operative to mark content. In another exemplary embodiment, the system can further include a network that can be wireless or wired. In another exemplary embodiment, the system can further include a server including a second processor, a second memory and storage media.

In an exemplary embodiment, the marker module can be displayed, a wireless communication enabled software application, a standalone software application, or a task bar software application.

In an exemplary embodiment, the marker module is operative to manage a hierarchy of tag and subtag attributes, can include a creator module operative to create a new tag attribute can include a first selector operative to select a parent tag attribute, and an assignor operative to assign a new child tag attribute to the parent tag attribute, a change module operative to change a hierarchical relationship of one tag attribute and subtag attributes of the one tag attribute can include a reassignor operative to reassign the one tag attribute and the subtag attributes of the one tag attribute to a different parent tag attribute, a first deletor operative to delete an undesired tag attribute can include a second selector operative to select the undesired tag attribute, and a second deletor operative to delete the undesired tag attribute and any subtag attributes of the undesired tag attribute, a renamer operative to rename a misnamed tag attribute, or a display operative to display the hierarchy of tag and subtag attributes as a tag tree list. In an exemplary embodiment, the marker module further can include an associator operative to associate any of the tag attributes with any of the content can include a third selector operative to select the any of the tag attributes, and a tag associator operative to associate the any of the tag attributes with one or more content records of the content. In an exemplary embodiment, the tag associator is operative to drag and drop the one or more tags from the tag tree list to the content records or the capture window. In an exemplary embodiment, the hierarchy of tag and subtag attributes can include at least one root tag, and where each tag beginning from the root tag can have one or more subtags assigned to the each tag, and each subtag is a tag, and the each subtag is assigned as a child tag of one parent tag.

In another exemplary embodiment of the invention, a computer program product can be embodied on a computer readable medium, the computer program product can include program logic where the computer program product can include marker program code means for enabling a processor to associate user definable attributes with content; and searcher program code means for enabling the processor to search the content using the user definable attributes as a search index.

In an exemplary embodiment, the computer program product can further include catcher program code means for enabling the processor to catch and register the content in a database having an hierarchical album structure.

In another exemplary embodiment of the invention, a computer program product can be embodied on a computer readable medium, the computer program product can include program logic where the computer program product can include catcher program code means for enabling a processor to catch and register content in a database having an hierarchical album structure.

In an exemplary embodiment, the computer program product can further include manager program code means for enabling the processor to organize the content.

In an exemplary embodiment, computer program product can further include marker program code means for enabling the processor to associate user definable attributes with the content; and searcher program code means for enabling the processor to search the content using the user definable attributes as a search index.

When the number of tags increases, e.g., to hundreds or more, the user can have difficulty finding a suitable tag. This increases the chance that the user will create a tag which is very similar to a tag that already exists. For example, “car” and “cars”, and the problem can grow as the tags multiply exponentially, making the tag system even more difficult to use.

Advantageously, the present invention can make it possible to access the tags by first choosing “parent” tags, e.g., “Fruit” and then “children” tags, e.g., “Apples.” The organization of the tag system can be made much easier and the structure of the system made more logical by maintaining tags in one place; and allowing the system to recognize the relationship between tags.

When a user attaches a tag to a file, the present invention already recognizes a significant amount of information about the file. For example, the tag “John” can be a sub-tag of “My Family.” The user can drag the tag “John” to a file. The system can detect that the tag “John” is related to the parent tag “My family.”

When the user searches for the tag “John,” all files to which the tag “John” has been attached can appear. When the user searches for the tag “My Family” all photos/files of “John” and other family members can appear. The results can appear although the user did not tag the photo with the tag “My Family.” The system can resolve this from the relatedness of tags.

Advantageously, the present invention can provide for hierarchical tagging and inheritance of parent tag attributes. A photo having the filename “Apple” attached to it would not be found by searching for “Fruit”. When a user searches “Fruit” files, “Apple” would not conventionally be found. The marker's tag system of the present invention advantageously can locate content tagged “Apple” when the tags for “Fruits” are searched.

The present invention can also give the user the ability to change the tag system in an easy and convenient manner. If the user desires to improve the informative value of the present system (Food-Apple) and add the tag “Fruit” in between “Food” and “Apple,” then the user can do so easily. By simply adding the tag “Fruit” to the Food-Apple family tree, all photos that have the tag “Apple” attached to them can now be located with the tag “Fruit.”

If the tag “Fruit” is deleted from the tag system (“Food-Fruit-Apple”) then the tag “Fruit” can be automatically removed from all photos that had the tag “Apple” attached to it.

If the tag “Fruit” is only removed from a certain photo/file (but the tag is still in the system) then the “Fruit” tag can still remain on the rest of the content which had been tagged with “Fruit.”

With the marker of the present invention, the user can move the tag “Fruit” and can give the tag a new parent.

The search of the present invention is very powerful as the searcher allows looking for content from the intersection point of an content in the album can be found. The user can choose how much data will become visible when searching.

Thus, for example, it can be easy to find all holiday photos of certain family members and photos of special occasions.

Advantageously, the manager can help organize content of, e.g., a user, a business, a worker, a consumer, an employee and a student. Marking hierarchical categories can be used as a method of organizing the tangible as well as the intangible, e.g., digital content.

Another advantage to the present invention is the modularity of the present invention. The present invention advantageously can allow a user to order or license the software by module.

Another feature of the invention can include providing compensation to affiliate business partners that provide complementary services.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings. In the drawings, like reference numbers generally indicate identical, functionally similar, and/or structurally similar elements. The left most digits in the corresponding reference number indicate the drawing in which an element appears first.

FIG. 1A depicts a block diagram with components of an exemplary embodiment of a content management system including a catcher, a manager, a marker, a searcher, a fixer and a player according to the present invention;

FIG. 1B depicts a block diagram of an exemplary system according to the present invention;

FIG. 2A depicts a graphical user interface (GUI) of an exemplary implementation of the catcher according to the present invention;

FIG. 2B depicts an exemplary Windows™ taskbar embodiment of the catcher and the searcher according to the present invention;

FIG. 3A depicts two exemplary embodiments of a method of registering content with the manager according to the present invention;

FIG. 3B depicts a third exemplary embodiment of a method of registering content with the manager according to the present invention;

FIG. 3C depicts a fourth exemplary embodiment of a method of registering content with the manager through the taskbar implementation of the catcher according to the present invention;

FIG. 4 depicts a GUI of an exemplary embodiment of the manager application, showing an album list, a preview window, content records and content record attributes according to the present invention;

FIG. 5 depicts a GUI of an exemplary embodiment of a properties window of a content record in the manager, showing the content record's attributes according to the present invention;

FIG. 6 depicts a GUI of an exemplary embodiment of the marker application, showing a tag hierarchy list according to the present invention;

FIG. 7A depicts an exemplary embodiment of a method of marking content in the manager with tags from the marker according to the present invention;

FIG. 7B depicts a second exemplary embodiment of a method of marking content in the manager properties window from the marker according to the present invention;

FIG. 8 depicts exemplary content record attributes, the values of which the Searcher can query;

FIG. 9A depicts two exemplary embodiments of the searcher application GUI, one for a basic search and one for an advanced search according to the present invention;

FIG. 9B depicts exemplary search results as displayed in an exemplary embodiment of the manager according to the present invention;

FIG. 9C depicts another exemplary embodiment of the searcher and an exemplary embodiment of a search result display according to the present invention; and

FIG. 10 depicts an exemplary computer system.

### DETAILED DESCRIPTION OF AN EXEMPLARY EMBODIMENT OF THE PRESENT INVENTION

A preferred embodiment of the invention is discussed in detail below. While specific exemplary implementation embodiments are discussed, it should be understood that this is done for illustration purposes only. A person skilled in the relevant art will recognize that other components and configurations may be used without parting from the spirit and scope of the invention.

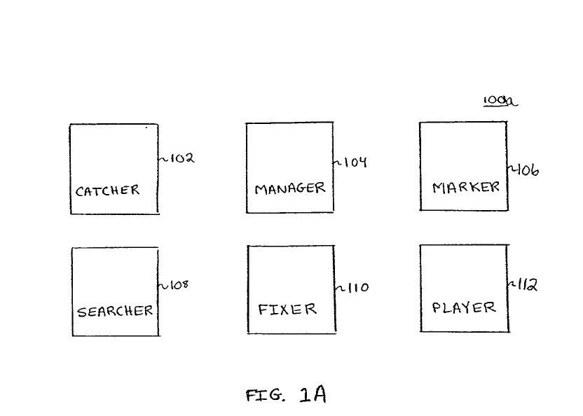

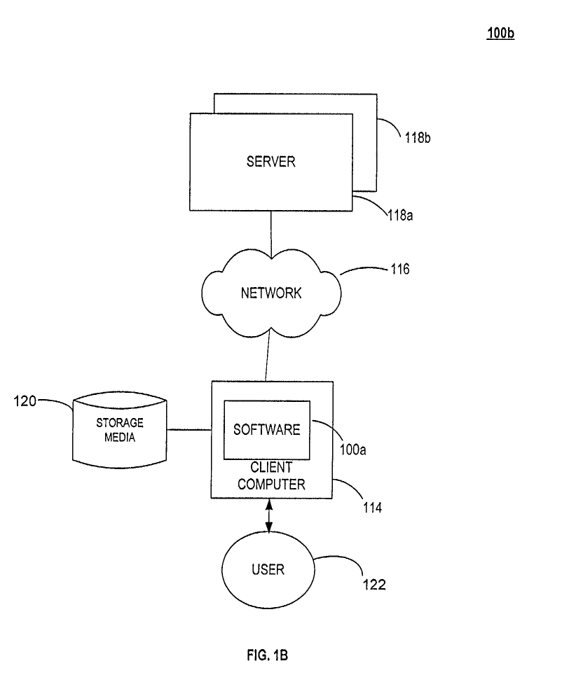

FIG. 1A depicts a block diagram 100a with components of an exemplary embodiment of a content management system including a catcher 102, a manager 104, a marker 106, a searcher 108, a fixer 110 and a player 112 according to the present invention.

Catcher 102 can be used to capture content from, e.g., email, a Web browser, a digital camera or a storage medium. Catcher 102 can further be used to add content to the content management system.

Manager 104 can be used to sort captured content into a user-defined storage structure. Manager 104 can also be used to edit attributes of captured content.

Marker 106 can be used to maintain a tag and sub-tag hierarchy. Marker tags can be applied to captured content to categorize the content.

Searcher 108 can be used to locate a user's captured content by searching on one or more of the content's attributes.

Fixer 110 can be used to edit image files, including, e.g. resizing, changing file format, adjusting color properties, and applying filters.

Player 112 can be used to view or listen to the contents of one or more of the user's content, including, e.g., still images, video, and sound files. Player 112 can also be used to create portable slide-shows of image files.

FIG. 1B depicts a block diagram 100b of an exemplary system according to the present invention. Block diagram 100b can include a user 122 interacting with a client computer 114 to access content on storage media 120 and servers 118a, 188b. Client computer 114 can include an operating system (not shown) and software application programs 100a. Client computer 114 can be coupled in an exemplary embodiment to server 118a, 118b by network 116.

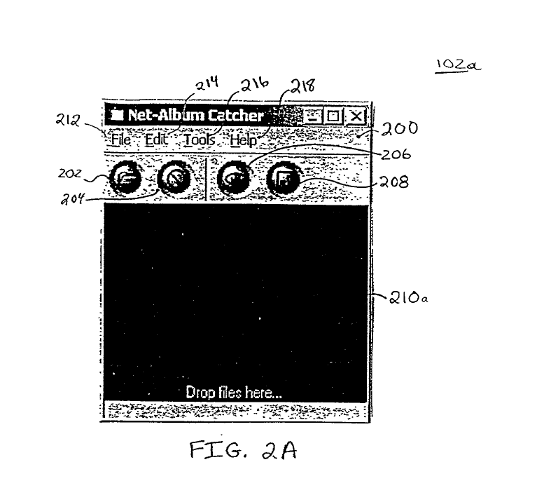

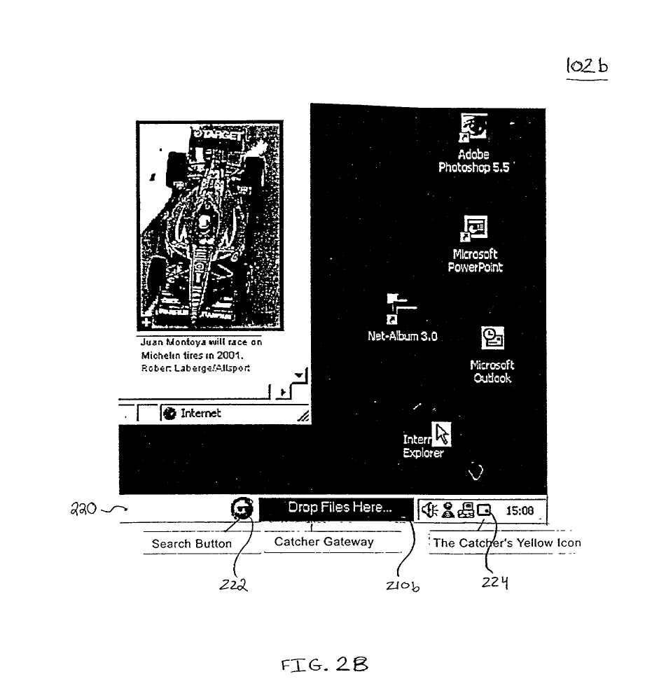

FIG. 2A depicts a graphical user interface (GUI) 102a of an exemplary implementation of catcher 102 according to the present invention. The GUI can include a window 200. Window 200 can include an insert file button 202, a stop file import button 204, an import file from camera or scanner button 206 and a launch manager button 208. Window 200 can further include a file menu 212, an edit menu 214, a tools menu 216 and a help menu 218. Window 200 can further include a drag-and-drop aware area 210a.

FIG. 2B depicts an exemplary Windows™ taskbar embodiment 102b of a catcher and a searcher. A Windows™ taskbar 220 is shown. Taskbar 220 can include a searcher button 222, a drag-and-drop aware catcher gateway task bar panel 210b and a double-clickable catcher icon 224.

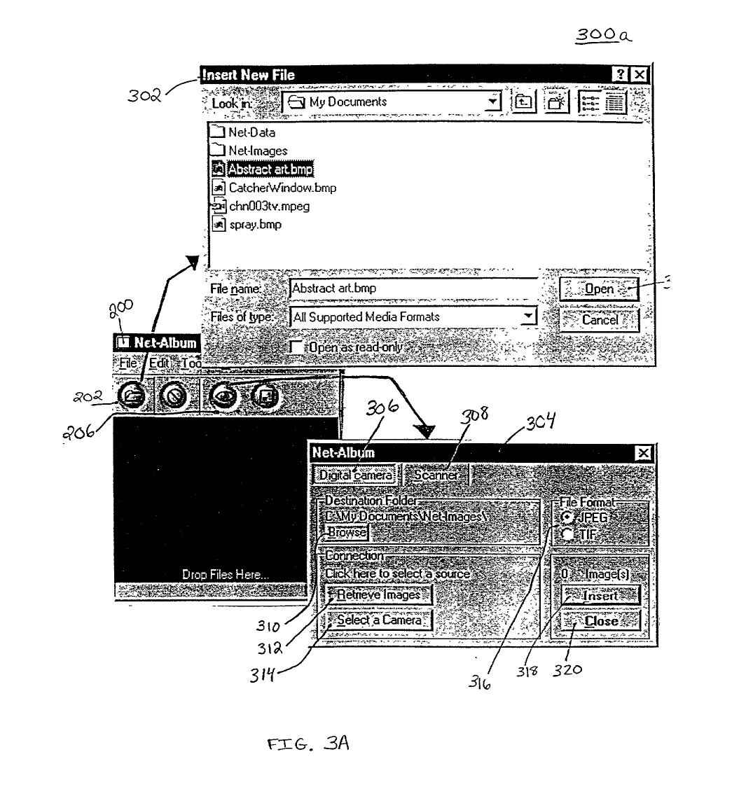

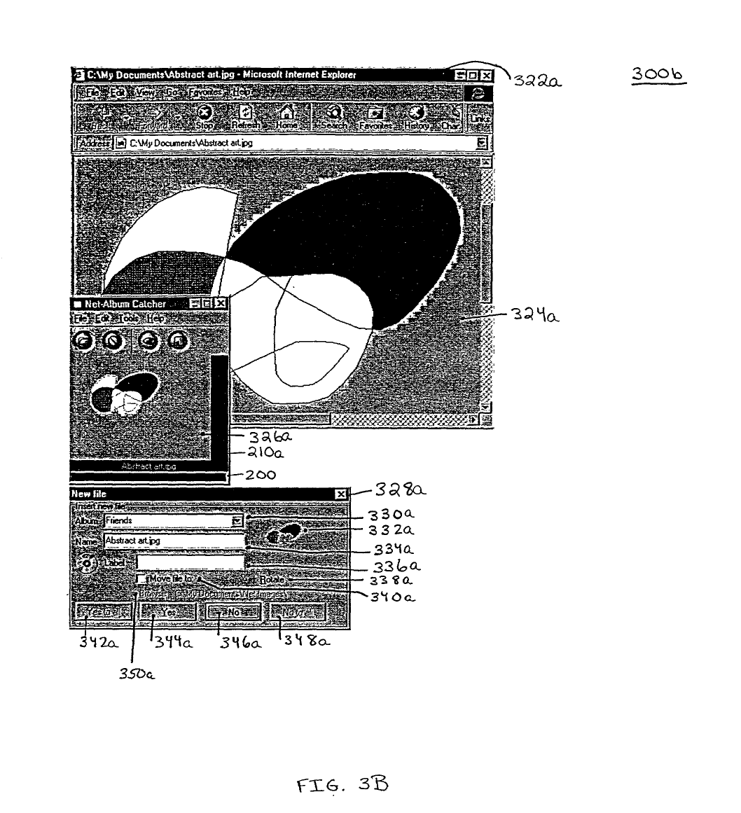

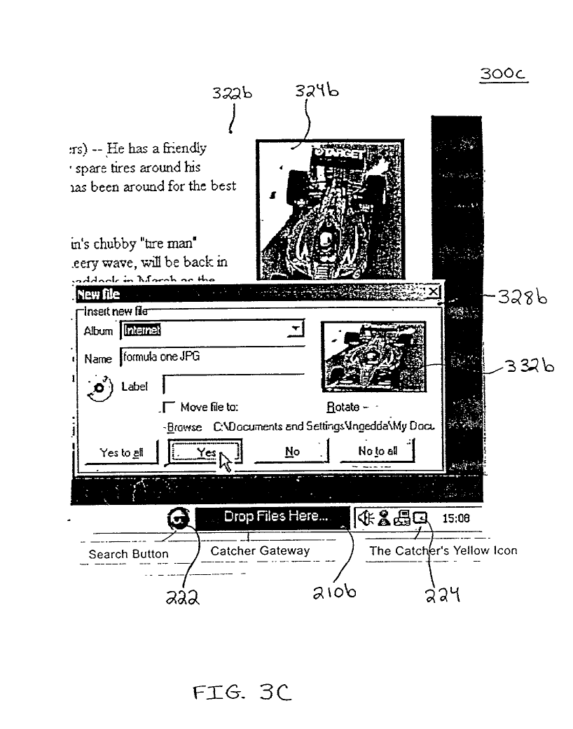

FIG. 3A depicts two exemplary embodiments 300a of a method of registering content with the manager according to the present invention. Catcher window 200 is shown. The user can press an insert file button 202. Pressing button 202 can cause a standard Windows™ file browser dialog window 302 to open. The user can then browse to the location of the user's file and press open button 321 to insert the file into the content management system. Alternatively, the user can press an import file from camera or scanner button 206. Pressing button 206 causes dialog window 304 to open. Dialog window 304 can include a digital camera tab 306, and a scanner tab 308. Dialog window 304 can further include browse button 310, a select a camera button 314, a retrieve images button 312, a file format radio button dialog 316, an insert button 318, and a close button 320. The user can select the disk directory where the imported file will be stored with browse button 310. The user can choose which camera to connect to using the select a camera button 314. To retrieve the images from the selected camera, the user presses the retrieve images button 312. The file format of the incoming files can be chosen in the file format radio button dialog 316. The user presses the insert button 318 to add the file(s) to the manager. The user can close the dialog window 304 with the close button 320.

FIG. 3B depicts a third exemplary embodiment 300b of a method of registering content with the manager according to the present invention. A user using drag-and-drop capable software 322a such as, e.g., Microsoft™ Internet Explorer™, can drag an image 324a, or other content, from the drag-and-drop capable software to a catcher window 200 and drop it in the drag-and-drop aware area 210a of catcher window 200. Image 324a can be scaled to fit drag-and-drop area 210a. Catcher window 200 can display image 324a in area 210a. When the drag-and-drop operation is complete, a new file dialog window 328a can open. The new file dialog window 328a can include album menu 330a, name edit field 334a, label edit field 336a and thumbnail image 332a. Window 328a can further include a move file checkbox 340a, a rotate button 338a, a browse button 350a, a yes to all button 342a, a yes button 344a, a no button 346a, and a no to all button 348a. The user can change which album will hold the content in album menu 330a. The user can change the name of the content's file in the name edit field 334a. The user can enter a text label in the label edit field 336a. The user can rotate the thumbnail image 332a by using the rotate button 338a. The user can choose to store the content to an alternate location than that indicated by the browse button 350a by selecting the move file checkbox 340a. The user can select the alternate location by using the browse button 350a to change directories. When more than one item of content has been dragged to catcher window 200, the user can use the yes to all button 342a to add all content to the manager at once. Alternatively, the user can use the yes button 344a to add one item of content at a time. When the user chooses not to add content to the manager, the user can use the no button 346a to reject one file, or the no to all button 348a to reject all content dragged to catcher window 200.

FIG. 3C depicts a fourth exemplary method of registering content with the Manager through the taskbar implementation of the Catcher. A user using drag-and-drop capable software 322b such as, e.g., Microsoft™ Internet Explorer™, can drag an image 324b, or other content, from the drag-and-drop capable software to a a drag-and-drop aware catcher gateway task bar panel 210b. When the drag-and-drop operation is complete, a new file dialog window 328b can open. New file dialog window 328b is functionally identical to new file dialog window 328a. The reader is directed to the description of FIG. 3B above.

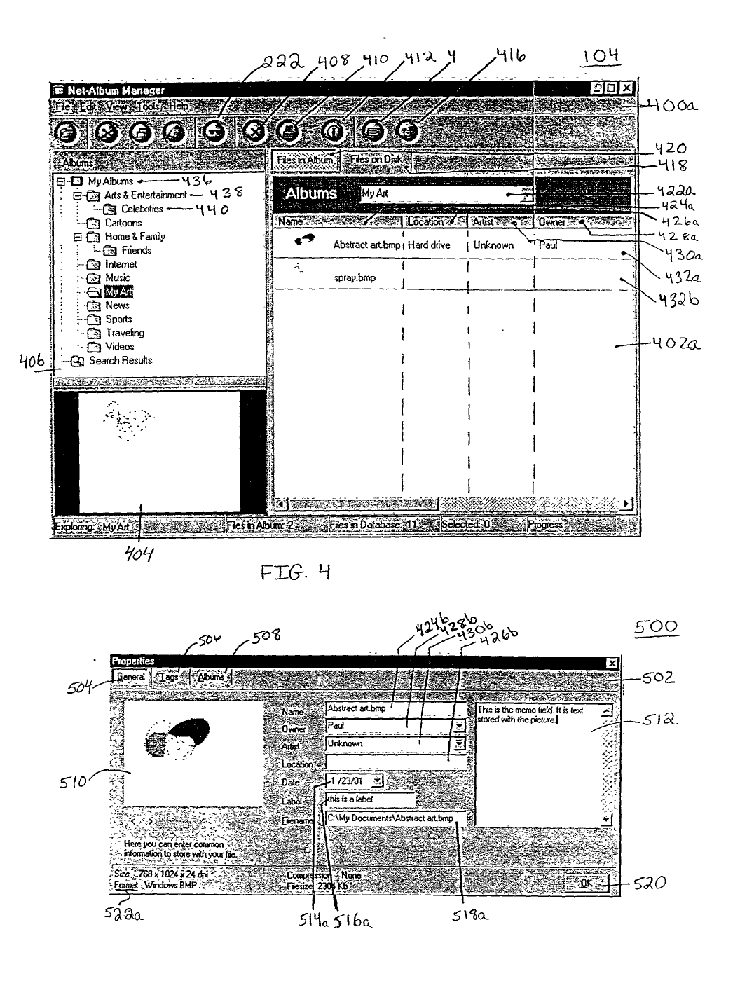

FIG. 4 depicts a GUI of an exemplary embodiment of the manager 104 according to the present invention. The GUI can include a window 400a. Window 400a can include a searcher button 222, a delete files button 408, a print button 410, a properties button 412, a marker button 414 and a player button 416. Window 400a can further include an album list pane 406, a preview pane 404, content records pane 402a, a file in album tab 420a and a files on disk tab 418. The content records pane 402a can include content records 432a, 432b and album menu 422a. Content records 432a, 432b can include content record attributes. Such attributes can include, e.g., name 424a, location 426a, owner 428a, and artist 430a.

FIG. 5 depicts a GUI 500 of an exemplary embodiment of a properties window 502 of a content record in the manager. A user can use properties button 412 to open window 502 when a content record 432a,432b is selected in manager window 400a. Properties window 502 can include a general tab 504, a tags tab 506, and an albums tab 508. A properties window 502 can further include a preview pane 510, a memo field 512, a format label 522 and an ok button 520. When general tab 504 is selected, window 502 can further include a name edit field 424b, an owner menu 428b, an artist menu 430b, a location edit field 426b, a date menu 514, a label edit field 516a and a filename edit field 518a. Memo field 512 can be populated by a drag-and-drop operation of selected text, audio or video annotations and the like to the catcher window (not shown).

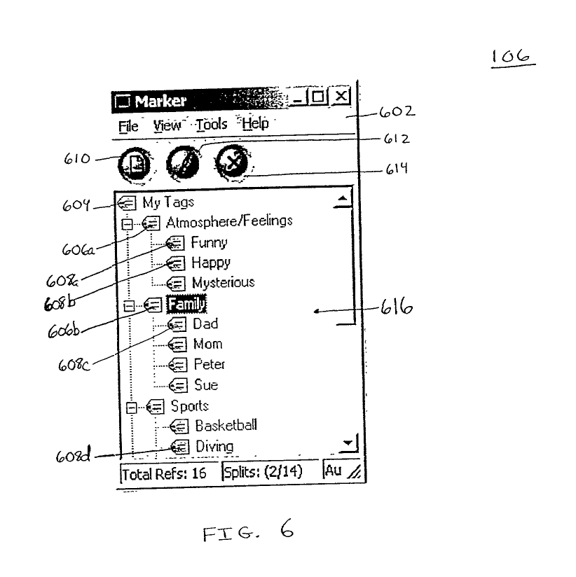

FIG. 6 depicts a GUI of an exemplary embodiment of the marker 106 application according to the present invention. The GUI can include a window 602. Window 602 can include a new tag button 610, a rename tag button 612, a delete tag button 614 and a tag list pane 616. Tag list pane 616 can include a root tag 604, parent tags 606a, 606b and sub-tags 608a, 608b, 608c, 608d. The user can create, rename, rearrange and delete parent tags and sub-tags.

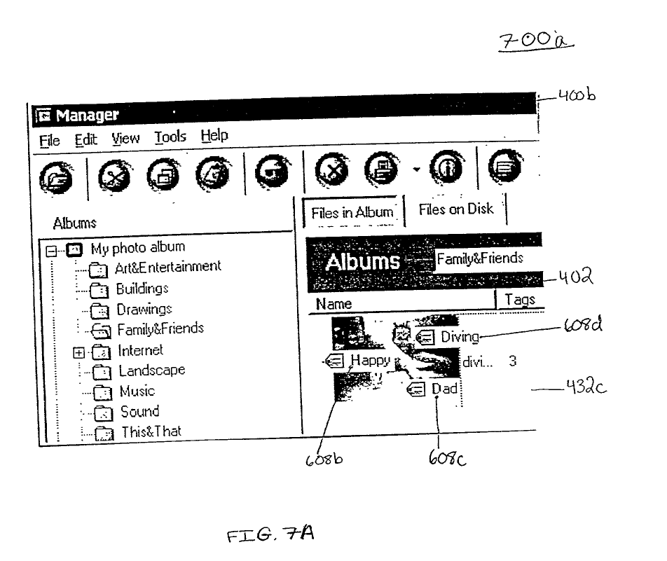

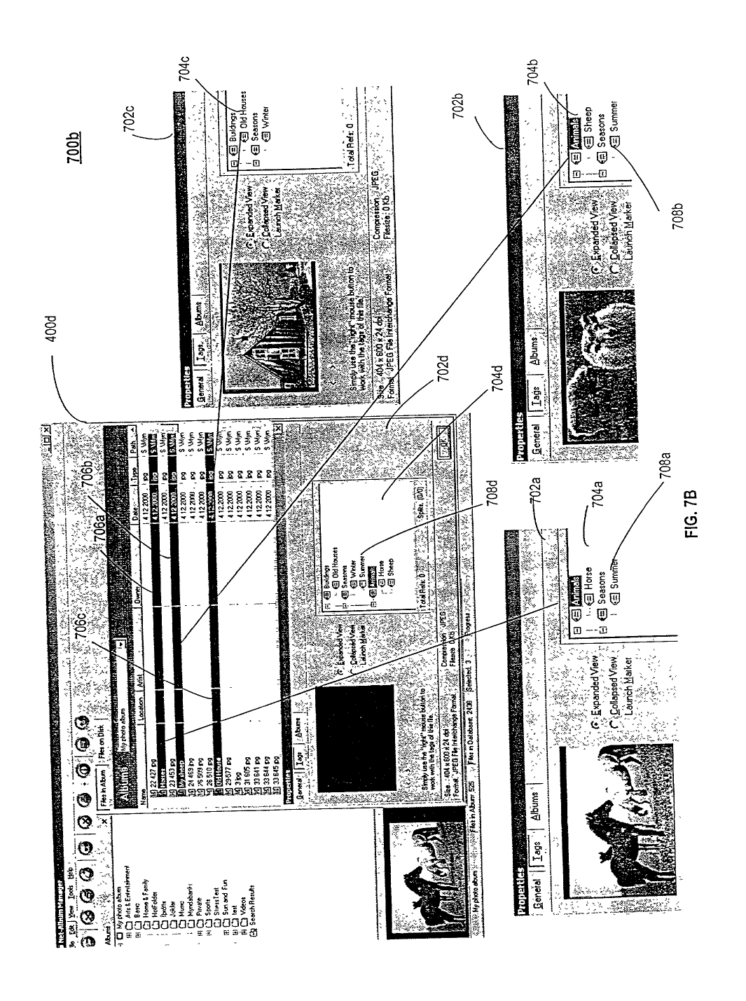

FIG. 7A depicts an exemplary embodiment of a method 700a of marking content in the manager with tags from the marker according to the present invention. A user can drag tags 608b, 608c, 608d from a marker 106 (not shown, see FIG. 6) to a manager window 400b. The user can drop tags 608b, 608c, 608d onto a content record 432c in content records pane 402. The tags 608b,608c,608d are said to be associated with content record 432c.

FIG. 7B depicts a second exemplary embodiment of a method 700b of marking content in the manager properties window from the marker according to the present invention. Content records 706a, 706b, 706c are selected in the manager window 400d. Portions of the properties window 702a, 702b, 702c are shown where properties window 702a corresponds to content record 706a, properties window 702b corresponds to content record 706b, and properties window 702c corresponds to content record 706c. Note that the user has selected the Tags tab (not marked) in each properties window. Properties window 702a, 702b, 702c can display the tags that have been associated with the content record 706a, 706b, 706c in tags pane 704a, 704b, 704c. Note that content records 706a and 706b have a tag 708a, 708b (“summer”) in common. A fourth properties window 702d can display the tags of multiply selected content records in tags pane 704d. Note that the tags of each content record are displayed collectively in one tag pane 704d. The tag 708a, 708b is displayed in tags pane 704d, but not in tags pane 704c, because tag 708a, 708b, 708d has not been associated with content record 706c. Similarly, tag 704c (“Old Houses”) is displayed in 704c, 704d but not in 704a, 704b. A user can drag and drop tags from a marker 106 (not shown) to tags pane 704d to associate a tag with multiple selected content records. A user can further remove a tag association from multiple selected content records by deleting a tag from tag pane 704d.

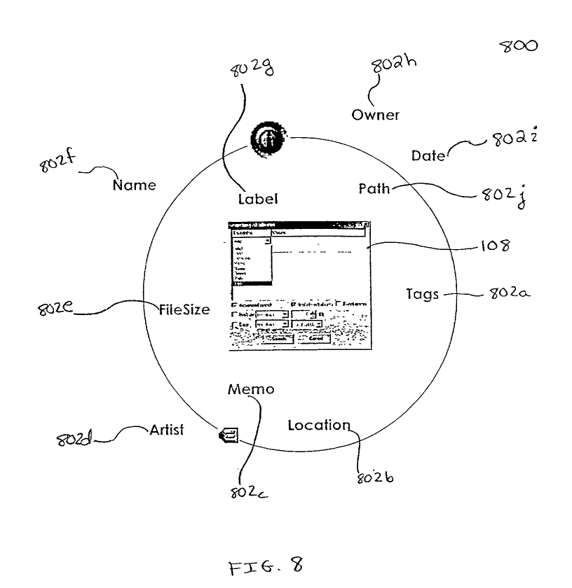

FIG. 8 depicts diagram 800 showing exemplary content record attributes, the values of which the searcher can query according to the present invention. Searcher 108 can perform a search to retrieve content records from the manager by searching on specific values of any combination of the attributes tags 802a, location 802b, memo 802c, artist 802d, file size 802e, name 802f, label 806g, owner 802h, date 802i, and path 802j.

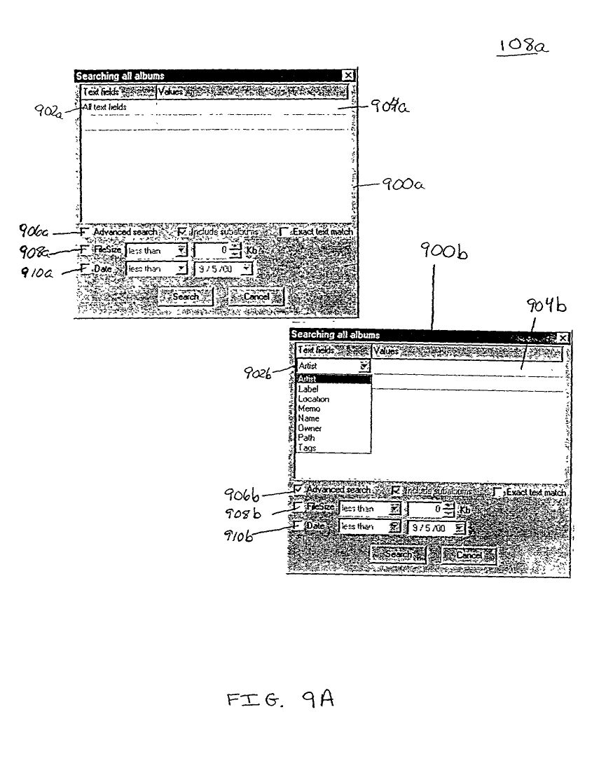

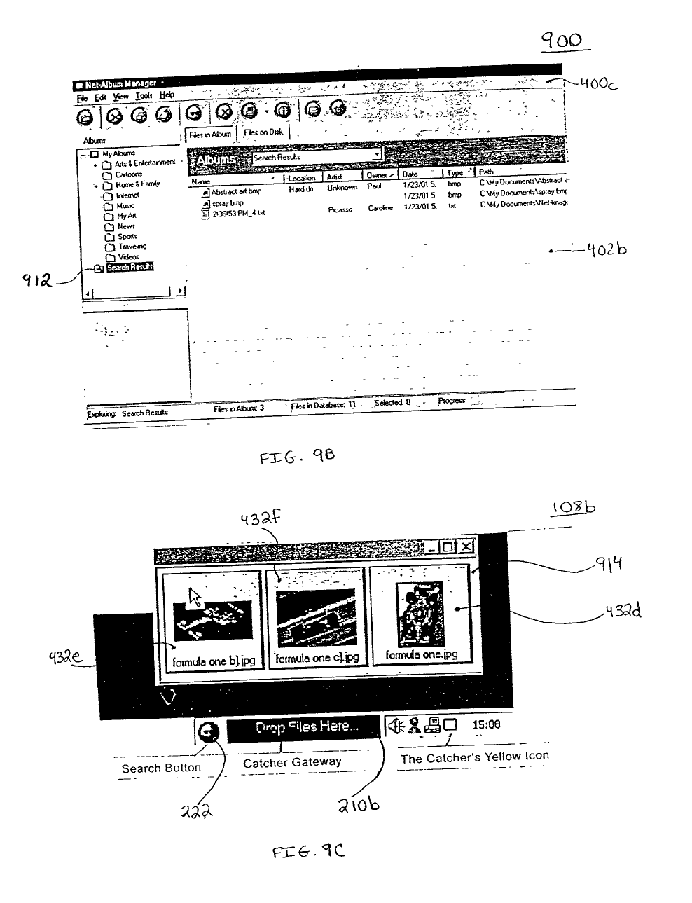

FIG. 9A depicts two exemplary embodiments of a GUI 108a of the searcher 108. Searcher window 900a can include a search field 902a. Search field 902a can direct a content search on all text field attributes where the specific value is as specified in value field 904a. The user can access advanced searcher window 900b by using advanced search checkbox 906a. From advanced searcher window 900b, the user can search for content by selecting specific attribute values in search field menu 902b to narrow the search. From 900a, 900b, the user can search for content of a specific file size by selecting the file size checkbox 908a, 908b. From 900a, 900b, the user can search for content on a specific date or in a date range by selecting the date checkbox 910a, 910b.

FIG. 9B depicts exemplary search results 900 as displayed in a manager window 400c. Content records pane 402b lists the content records 432a, 432b, 432c of the search results album 912. The search results album 912 provides a means of displaying content records from one or more other albums together in one content record pane.

FIG. 9C depicts another exemplary embodiment 108b of the searcher and an exemplary embodiment of a search result display according to the present invention. The user can enter a search word into a catcher gateway task bar panel 210b. The user can then use the search button 222 to begin the search. Search results can be displayed in a window 914, which can include content record buttons 432d, 432e, 432f. The user can drag the content record button of interest to an email message to send the content as an attachment (not shown). Alternatively, the user can select the content record button of interest and view it.

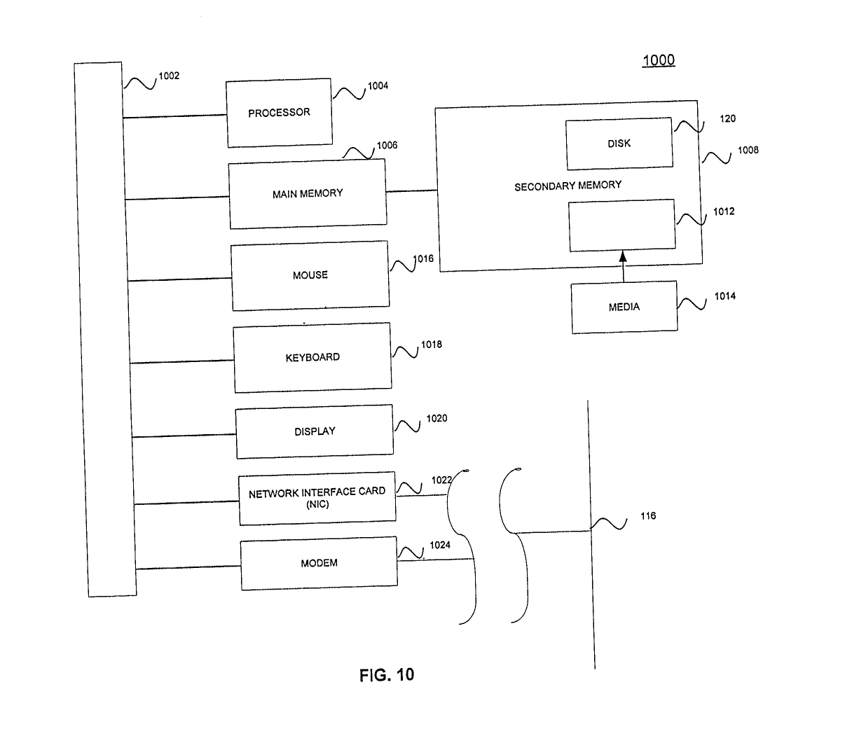

FIG. 10 depicts an exemplary embodiment of a computer system that could be used in the present invention. Specifically, FIG. 10 illustrates an exemplary embodiment of a computer 114, 118 in a preferred embodiment is a client or server computer that can include, e.g., a personal computer (PC) system running an operating system such as, e.g., Windows NT/98/2000/CE, LINUX, OS/2, Mac/OS, or other variant of the UNIX operating system. However, the invention is not limited to these platforms. Instead, the invention can be implemented on any appropriate computer system running any appropriate operating system, such as Solaris, Irix, Linux, HPUX, OSF, Windows 98, Windows NT, OS/2, Mac/OS, and any others that can support Internet access. In one embodiment, the present invention is implemented on a computer system operating as discussed herein. An exemplary computer system, computer 114, 118 is illustrated in FIG. 10. Other components of the invention, such as client workstations, proxy servers, network communication servers, remote access devices, client computers, server computers, routers, web servers, data, media, audio, video, telephony or streaming technology servers could also be implemented using a computer such as that shown in FIG. 10.

The computer system 114, 118 includes one or more processors, such as processor 1004. The processor 1004 is connected to a communication bus 1002.

The computer system 114, 118 also include a main memory 1006, preferably random access memory (RAM), and a secondary memory 1008. The secondary memory 1008 can include, e.g., a hard disk drive 120, or storage area network (SAN) and/or a removable storage drive 1012, representing a floppy diskette drive, a magnetic tape drive, a compact disk drive, etc. The removable storage drive 1012 reads from and/or writes to a removable storage unit 1014 in a well known manner.

Removable storage unit 1014, also called a program storage device or a computer program product, represents a floppy disk, magnetic tape, compact disk, etc. The removable storage unit 1014 includes a computer usable storage medium having stored therein computer software and/or data, such as an object's methods and data.

Computer 114, 118 also includes an input device such as (but not limited to) a mouse 1016 or other pointing device such as a digitizer, and a keyboard 1018 or other data entry device.

Computer 114, 118 can also include output devices, such as, e.g., display 1020. Computer 114, 118 can include input/output (I/O) devices such as, e.g., network interface cards 1022 and modem 1024.

Computer programs (also called computer control logic), including object oriented computer programs, are stored in main memory 1006 and/or the secondary memory 1008 and/or removable storage units 1014, also called computer program products. Such computer programs, when executed, enable the computer system 114, 118 to perform the features of the present invention as discussed herein. In particular, the computer programs, when executed, enable the processor 1004 to perform the features of the present invention. Accordingly, such computer programs represent controllers of the computer system 104, 108, 114.

In another embodiment, the invention is directed to a computer program product comprising a computer readable medium having control logic (computer software) stored therein. The control logic, when executed by the processor 1004, causes the processor 1004 to perform the functions of the invention as described herein.

In yet another embodiment, the invention is implemented primarily in hardware using, e.g., one or more state machines. Implementation of these state machines so as to perform the functions described herein will be apparent to persons skilled in the relevant arts.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of organizing content comprising:
(a) catching content comprising
(1) registering said content in a database.

2. The method according to claim 1, wherein said step (a)(1) comprises:
(A) generating a copy of said content, wherein said copy is stored in at least one of a common directory and a selected directory.

3. The method according to claim 2, wherein said step (a)(1)(A) comprises:
(i) compressing said content.

4. The method according to claim 1, wherein said step (a)(1) comprises:
(A) assigning said content to an album.

5. The method according to claim 4, wherein said step (a)(1)(A) comprises:
(i) selecting an album from a group of albums wherein at least one of
said album and said group of albums do not correspond directly to a file directory structure of an operating system;
said group of albums comprise at least one of
art and entertainment,
cartoons,
home and family,
internet,
music,
news,
sports,
traveling, and
videos;
said albums and said group of albums are user customizable; and
said albums and said group of albums are user selectable at installation.

6. The method according to claim 1, wherein said step (a) is performed by a catcher and wherein said catcher performs at least one of
displaying a catcher window,
communicating wirelessly,
standing alone as an independent software application, and
displaying a task bar version of said catcher.

7. The method according to claim 1, wherein said database is at least one of a manager and an album database of user-definable albums.

8. The method according to claim 1, wherein said step (a) further comprises:
(2) previewing said content.

9. The method according to claim 1, wherein said step (a) further comprises:
(2) capturing said content.

10. The method according to claim 9, wherein said step (a)(2) comprises:
(A) receiving said content from at least one of
a main memory;
a secondary memory;
storage media;
a browser;
a scanner;
a microphone;
a line in;
a digital camera;
a source of content; and
a video camera.

11. The method according to claim 10, wherein said step (a)(2)(A) comprises said storage media, wherein said storage media is at least one of
a hard disk,
removable media,
CD-ROM,
DVD,
Flash memory,
a floppy disk,
a ZIP drive,
an optical storage device,
a magneto-optical storage device, and
a magnetic storage device.

12. The method according to claim 1, wherein said step (a) further comprises:
(2) storing said content to a storage media.

13. The method according to claim 12, wherein said step (a)(2) comprises:
(A) storing content wherein said content comprises at least one of data, digital images, text, audio, music, video, and movies.

14. The method according to claim 1, wherein said step (a) further comprises:
(2) setting attributes of said content within said database.

15. The method according to claim 14, wherein said step (a)(2) comprises:
(A) setting attributes wherein said attributes comprise at least one of
a tag attribute,
a user definable attribute,
an album attribute,
a name attribute,
a name of a copy of a file,
an owner attribute,
an artist attribute,
a location attribute,
a content attribute,
an audio attribute,
a video attribute,
a universal resource locator attribute,
a memo attribute,
a filename and path attribute,
a label attribute,
an identifier of storage media,
other fixed attributes, and
other user definable attributes.

16. The method according to claim 1, wherein said step (a)(1) comprises:
(A) dragging said content to a capture window; and
(B) dropping said content into said capture window.

17. The method according to claim 1, wherein said step (a)(1) comprises at least one of:
(A) selecting a menu choice;
(B) selecting a button;
(C) selecting a menu choice from a popup menu associated with content; and
(D) browsing user's files to select content to register.

18. The method according to claim 1, wherein said step (a)(1) comprises:
(A) generating a copy of said content.

19. The method according to claim 18, wherein said step (a)(1)(A) comprises:
(i) assigning a user-specified location on storage media.

20. The method according to claim 1, wherein said step (a) further comprises:
(2) assigning content to existing content as a memo attribute.

21. The method according to claim 1, further comprising:
(b) managing said content comprising at least one of
(1) organizing said content in an album of a group of albums in a hierarchical album structure wherein said hierarchical album structure need not mirror an operating system file directory structure;
(2) displaying said hierarchical album structure as a collapsible and expandable album tree;
(3) displaying attributes of said content wherein said attributes comprise at least one of
a tag attribute,
a user definable attribute,
an album attribute,
a name attribute,
a name of a copy of a file,
an owner attribute,
an artist attribute,
a location attribute,
a content attribute,
an audio attribute,
a video attribute,
a universal resource locator attribute,
a memo attribute,
a filename and path attribute,
a label attribute,
an identifier of storage media,
other fixed attributes, and
other user definable attributes;
(4) modifying attributes wherein said attributes comprise at least one of
a tag attribute,
a user definable attribute,
an album attribute,
a name attribute,
a name of a copy of a file,
an owner attribute,
an artist attribute,
a location attribute,
a content attribute,
an audio attribute,
a video attribute,
a universal resource locator attribute,
a memo attribute,
a filename and path attribute,
a label attribute,
an identifier of storage media,
other fixed attributes, and
other user definable attributes; and
(5) previewing said content;
(6) outputting said content to at least one of a display and a printer;
(7) generating one or more thumbnail views of said content and at least one of displaying, storing, and outputting at least one of said one or more thumbnail views and details associated with said one or more thumbnail views.

22. The method according to claim 21, wherein each of said step (a) and said step (b) can be a separate software application program.

23. The method according to claim 21, further comprising:
(c) marking said content comprising
(1) managing a hierarchy of tag and subtag attributes, comprising at least one of
(A) creating a new tag attribute including
(i) selecting a parent tag attribute, and
(ii) assigning a new child tag attribute to said parent tag attribute,
(B) changing a hierarchical relationship of one tag attribute and subtag attributes of said one tag attribute including
(i) reassigning said one tag attribute and said subtag attributes of said one tag attribute to a different parent tag attribute,
(C) deleting an undesired tag attribute including
(i) selecting said undesired tag attribute, and
(ii) deleting said undesired tag attribute and any subtag attributes of said undesired tag attribute,
(D) renaming a misnamed tag attribute, and
(E) displaying said hierarchy of tag and sub-tag attributes as a tag tree list.

24. The method according to claim 23, wherein said step (c) further comprises:
(2) associating any of said tag attributes with any of said content comprising
(A) selecting said any of said tag attributes, and
(B) associating said any of said tag attributes with one or more content records of said content.

25. The method according to claim 24, wherein said step (c)(2)(B) comprises:
(i) dragging and dropping said one or more tags from said tag tree list to at least one of said content records and said capture window.

26. The method according to claim 23, wherein said hierarchy of tag and subtag attributes comprises at least one root tag, and wherein each tag beginning from said root tag can have one or more subtags assigned to said each tag, and each subtag is a tag, and said each subtag is assigned as a child tag of one parent tag.

27. The method of claim 23, further comprising:
(d) searching said content comprising:
(1) selecting one or more search tag attributes,
(2) querying said database for matching content having said search tag attributes and subtags of said search tag attributes associated with said matching content.

28. The method of claim 23, further comprising:
(d) searching said content comprising:
(1) selecting at least one of a user-defined attributes,
(2) querying said database for matching content having said user-defined attributes associated with said matching content.

29. The method of claim 21, further comprising:
(c) fixing said content comprising at least one of:
importing, including at least one of
selecting said content,
opening said content, and
converting said content from a first format to a second format;
editing said content, including at least one of
rotating,
sizing,
zooming,
applying filters, and
adjusting colors;
storing said content;
viewing said content including at least one of
fitting content to window size, and
fitting window to content size;
cropping said content;
emailing said content; and
modifying said content according to criteria including at least one of file size, zooming, portion of image, user selection, automatically according to default criteria, and selectively according to selected criteria.

30. The method of claim 21, further comprising:
(c) playing said content comprising at least one of:
selecting said content;
organizing said content;
reordering said content;
appending said content;
displaying one or more content records of said content in at least one of a slideshow format, and said thumbnail views; and
exporting said slideshows as stand-alone viewable applications.

31. The method according to claim 21, wherein the method comprises
supporting multiple languages.

32. A method of marking content comprising:
(a) marking content comprising
(1) managing a hierarchy of tag and subtag attributes, comprising at least one of
(A) creating a new tag attribute including
(i) selecting a parent tag attribute, and
(ii) assigning a new child tag attribute to said parent tag attribute,
(B) changing a hierarchical relationship of one tag attribute and subtag attributes of said one tag attribute including
(i) reassigning said one tag attribute and said subtag attributes of said one tag attribute to a different parent tag attribute,
(C) deleting an undesired tag attribute including
(i) selecting said undesired tag attribute, and
(ii) deleting said undesired tag attribute and any subtag attributes of said undesired tag attribute,
(D) renaming a misnamed tag attribute, and
(E) displaying said hierarchy of tag and sub-tag attributes as a tag tree list.

33. The method according to claim 32, wherein said step (a) further comprises:
(2) associating any of said tag attributes with any of said content comprising
(A) selecting said any of said tag attributes, and
(B) associating said any of said tag attributes with one or more content records of said content.

34. The method according to claim 33, wherein said step (a)(2)(B) comprises:
(i) dragging and dropping said one or more tags from said tag tree list to at least one of said content records and said capture window.

35. The method according to claim 32, wherein said hierarchy of tag and subtag attributes comprises at least one root tag, and wherein each tag beginning from said root tag can have one or more subtags assigned to said each tag, and each subtag is a tag, and said each subtag is assigned as a child tag of one parent tag.

36. The method of claim 32, further comprising:
(b) searching said content comprising:
(1) selecting one or more search tag attributes,
(2) querying said database for matching content having said search tag attributes and subtags of said search tag attributes associated with said matching content.

37. The method of claim 32, further comprising:
(b) searching said content comprising:
(1) selecting at least one of a user-defined attributes,
(2) querying said database for matching content having said user-defined attributes associated with said matching content.

38. A method of organizing content comprising:
(a) managing content comprising at least one of
(1) organizing said content in an album of a group of albums in a hierarchical album structure wherein said hierarchical album structure need not mirror an operating system file directory structure;
(2) displaying said hierarchical album structure as a collapsible and expandable album tree;
(3) displaying attributes of said content wherein said attributes comprise at least one of
a tag attribute,
a user definable attribute,
an album attribute,
a name attribute,
a name of a copy of a file,
an owner attribute,
an artist attribute,
a location attribute,
a content attribute,
an audio attribute,
a video attribute,
a universal resource locator attribute,
a memo attribute,
a filename and path attribute,
a label attribute,
an identifier of storage media,
other fixed attributes, and
other user definable attributes;
(4) modifying attributes wherein said attributes comprise at least one of
a tag attribute,
a user definable attribute,
an album attribute,
a name attribute,
a name of a copy of a file,
an owner attribute,
an artist attribute,
a location attribute,
a content attribute,
an audio attribute,
a video attribute,
a universal resource locator attribute,
a memo attribute,
a filename and path attribute,
a label attribute,
an identifier of storage media,
other fixed attributes, and
other user definable attributes;
(5) previewing said content;
(6) outputting said content to at least one of a display and a printer;
(7) generating one or more thumbnail views of said content and at least one of displaying, storing, and outputting at least one of said one or more thumbnail views and details associated with said one or more thumbnail views.

39. A system that catches content comprising:
a processor;
a memory coupled to said processor; and
a catcher module executable on said processor operative to catch content.

40. The system according to claim 39, wherein said catcher module is at least one of displayed, a wireless communication enabled software application, a standalone software application, and a task bar software application.

41. A system that marks content comprising:
a processor;
a memory coupled to said processor;
a marker module executable on said processor operative to mark content.

42. The system according to claim 41, wherein said marker module is at least one of displayed, a wireless communication enabled software application, a standalone software application, and a task bar software application.

43. The system according to claim 41, wherein said marker module is operative to manage a hierarchy of tag and subtag attributes, comprising at least one of
a creator module operative to create a new tag attribute including
a first selector operative to select a parent tag attribute, and
an assignor operative to assign a new child tag attribute to said parent tag attribute,
a change module operative to change a hierarchical relationship of one tag attribute and subtag attributes of said one tag attribute including
a reassignor operative to reassign said one tag attribute and said subtag attributes of said one tag attribute to a different parent tag attribute,
a first deletor operative to delete an undesired tag attribute including
a second selector operative to select said undesired tag attribute, and
a second deletor operative to delete said undesired tag attribute and any subtag attributes of said undesired tag attribute,
a renamer operative to rename a misnamed tag attribute, and
a display operative to display said hierarchy of tag and sub-tag attributes as a tag tree list.

44. The system according to claim 43, wherein said marker module further comprises:
an associator operative to associate any of said tag attributes with any of said content comprising
a third selector operative to select said any of said tag attributes, and
a tag associator operative to associate said any of said tag attributes with one or more content records of said content.

45. The system according to claim 44, wherein said tag associator is operative to
drag and drop said one or more tags from said tag tree list to at least one of said content records and said capture window.

46. The system according to claim 43, wherein said hierarchy of tag and subtag attributes comprises at least one root tag, and wherein each tag beginning from said root tag can have one or more subtags assigned to said each tag, and each subtag is a tag, and said each subtag is assigned as a child tag of one parent tag.

47. A computer program product embodied on a computer readable medium, said computer program product comprising program logic wherein the computer program product comprises:
marker program code means for enabling a processor to associate user definable attributes with content; and
searcher program code means for enabling the processor to search said content using said user definable attributes as a search index.

48. The computer program product according to claim 47, further comprising:
catcher program code means for enabling the processor to catch and register said content in a database having an hierarchical album structure.

49. A computer program product embodied on a computer readable medium, said computer program product comprising program logic wherein the computer program product comprises:
catcher program code means for enabling a processor to catch and register content in a database having an hierarchical album structure.

50. The computer program product according to claim 49, further comprising:
manager program code means for enabling the processor to organize said content.

51. The computer program product according to claim 50, further comprising:
marker program code means for enabling the processor to associate user definable attributes with said content; and
searcher program code means for enabling the processor to search said content using said user definable attributes as a search index.
